(19) United States
(12) Patent Application Publication
(10) Pub. No.: US 2009/0056778 A1
(43) Pub. Date: Mar. 5, 2009

(54) Crutch foot

(76) Inventor: Christopher Dean, San Rafael, CA (US)

Correspondence Address: CHRISTOPHER DEAN, 4 TROST ROAD,, SAN RAFAEL, CA, 94901, US

(21) Appl. No.: 11/897,218

(22) Filed: Aug. 30, 2007

(51) Int. Cl. A45B 9/04; A61H 3/02

(52) U.S. Cl. 135/77

(57) ABSTRACT

Crutch foot with a foot or shoe shaped housing made of molded elastomeric plastic, the housing including an aperture that can slidably and fricionally engage with the lower portion of a crutch or cane shaft The aperture's lowest surface is sized to abut the top most surface of the cane's or the crutch's rubber tip so that the bottom most surface of the housing remains approximately one half of an inch above the ground plane when the crutch or cane is in use by a person. A preferred embodiment includes the housing being constructed of a low durometer plastic so that the aperture is capable of stretching over the crutch or cane rubber tip during installation and then returning to a shaft hugging dimension.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of crutch and cane accessories and more specifically to a decorative crutch foot.

Crutches and canes are well known in the medical profession and are prescribed as an aid to persons that have experienced an injury that requires them to not put pressure on their injured foot or leg. A crutch typically is comprised of a vertical support structure terminating at its top most position in a padded cradle that is meant to be positioned in the area of the user's armpit and at its lower most position terminating in a rubber or rubber-like tip that provides a pivot point and non-slip feature during use. Canes also provide vertical support and have a hand grip portion at their top and a rubber tip at their bottom.

In an attempt to provide some levity to an otherwise unpleasant event, the idea of adding an accessory that resembles a miniature foot or a shoe to the bottom of a cane or crutch has been put forward as is evidenced by U.S. Pat. No. D512,558 by Martinez and U.S. Pat. No. D516,799 by Gordon.

However, there is a deficiency in the prior technology in that the foot or shoe member shown in the prior art is meant to engage directly with the ground plane thereby interfering with the normal operation of the crutch or cane. The user of a cane or crutch relies on the rubber tip of the crutch or cane to be a pivot point for forward movement and also to be a frictional gripping surface to reduce the possibility of slipping while in use. Additionally, since the prior art sited consist of design patents, they do not cover the method of attachment to the cane and do not address how the user is to attach the foot or shoe shape securely to the crutch or cane.

### BRIEF SUMMARY OF THE INVENTION

The primary object of the invention is to provide a decorative crutch foot that attaches to the vertical support member of a crutch without interfering with the operation of the original crutch tip.

Another object of the invention is to provide a decorative crutch foot that does not interfere with the use of the crutch by a user.

Another object of the invention is to provide a decorative crutch foot that is easy to install.

A further object of the invention is to provide a decorative crutch foot that is economical to manufacture.

Yet another object of the invention is to provide a decorative crutch foot that fits on a variety of crutch or cane support members.

A further object of the invention is to provide an adaptor ring that can allow for differences in the height of the rubber tip found on most crutches and canes.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a crutch foot comprising: a foot or shoe shaped housing made of molded elastomeric plastic, said housing including an aperture that can slidably and fricionally engage with the lower portion of a crutch or cane shaft, and said aperture's lowest surface sized to abut the top most surface of said cane's or said crutch's rubber tip so that the bottom most surface of said housing remains approximately one half of an inch above the ground plane when said crutch or cane is in use by a person.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a side view of the invention in place on a cane or crutch shaft.

FIG. 2 is a front section view of the invention in place on a cane or crutch shaft.

FIG. 3 is a front section view of the invention including an adaptor ring.

FIG. 4 is an exploded view of the invention and a crutch tip.

FIG. 5 is a bottom view of the invention.

FIG. 6 is a top view of the invention.

FIG. 7 is a rear perspective view of the invention.

FIG. 8 is a front perspective view of the invention.

FIG. 9 is a perspective view of a dinosaur foot version of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

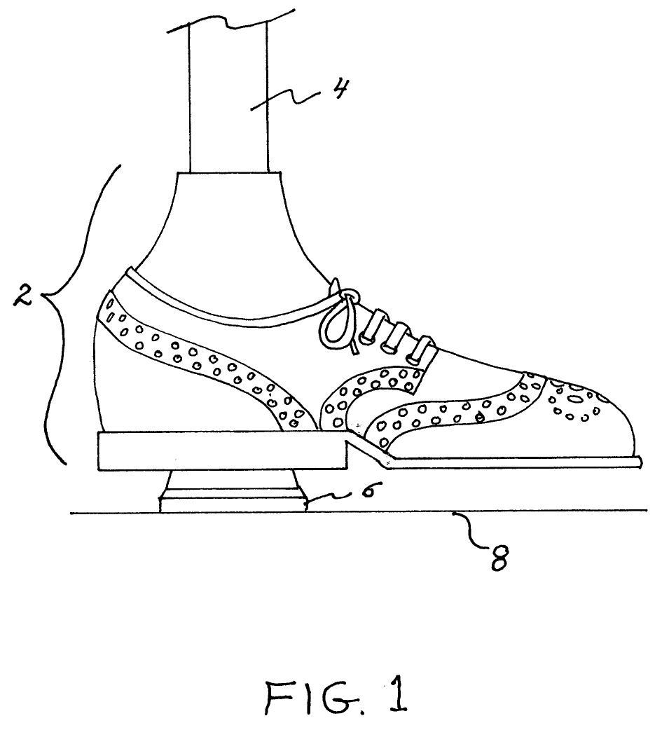

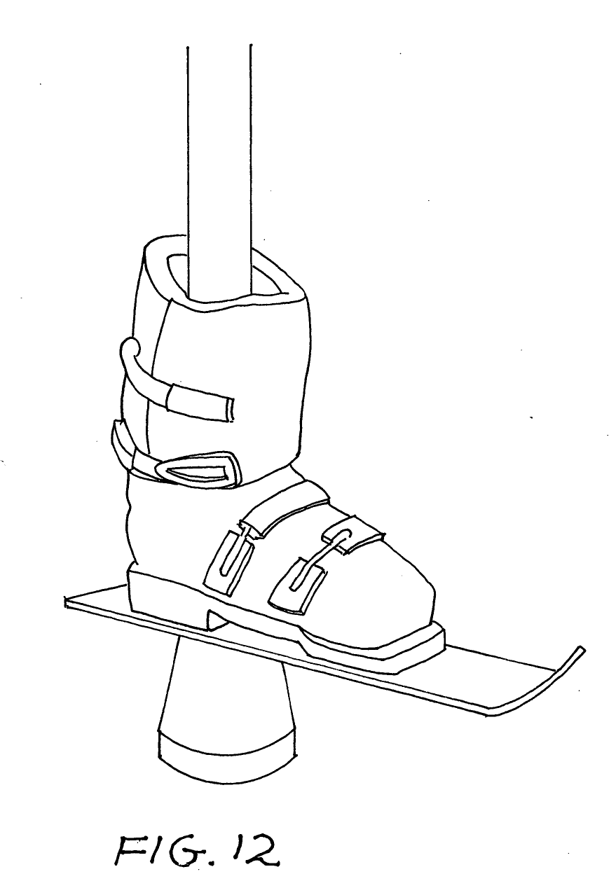

Referring now to FIG. 1 we see a side view of the crutch foot present invention 2. A standard crutch or cane shaft 4 extends through the center of the crutch foot housing 2. For purposes of simplicity, the term “crutch” will be used in the following description in place of the terms “crutch and cane”. The crutch foot of the present invention 2 can also be used on other items that include small diameter supporting structures such as furniture. The crutch shaft terminates in a standard rubber crutch tip 6. The crutch foot 2 is designed as a decorative housing in the shape of a miniature men's shoe, however it can also be shaped as a women's shoe, a bare foot, a sandal or an animals foot such as the dinosaur foot shown in FIG. 9.

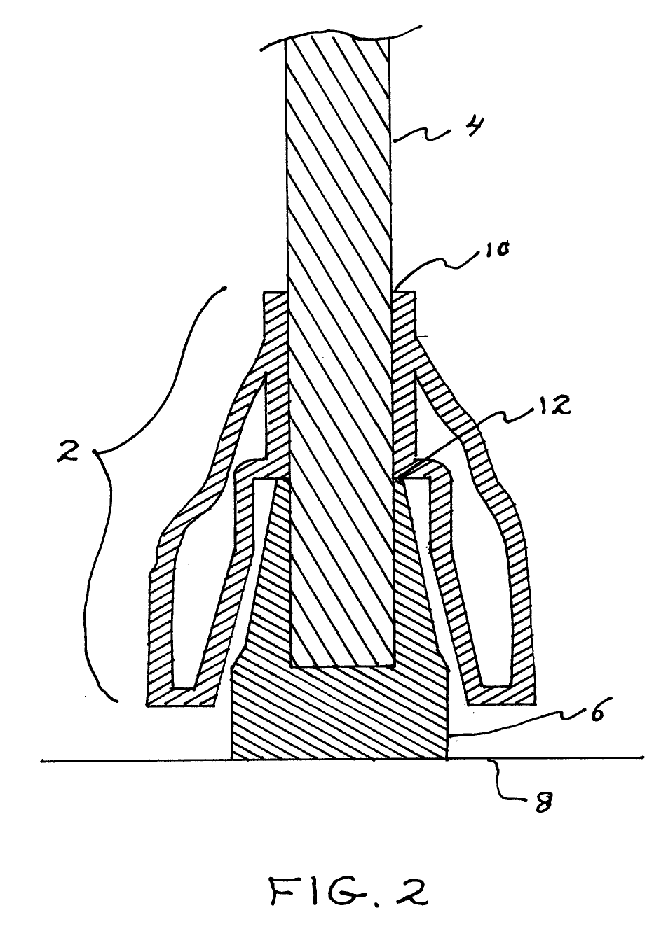

FIG. 2 shows a front section view as defined by the section line 20 shown in FIG. 6. The crutch foot housing 2 is made of molded elastomeric plastic. The crutch housing 2 slides over crutch shaft 4 so that the shaft exits housing 2 through aperture 5 and exits aperture 10 to terminate in standard rubber crutch tip 6. Aperture 10 is designed so that when the bottom of aperture 10 abuts the top of crutch tip 6 at location 12, the bottom of housing 2 remains above the ground plane 8 by approximately one half of an inch. Because of this configuration, the crutch tip bottom 6 is allowed to interact with the ground plane 8 in a normal way, retaining its ability to provide a pivot point for the crutch when in use as well as to provide an anti-slip function. It should be understood however that the distance between the bottom of the housing 2 and the ground plane can be as little as one eighth of an inch or as much as two inches. The housing 2 is then allowed to function as a decorative item only, and to not interfere with the normal use of the crutch. The diameter of crutch shaft 4 tends to be similar in most crutches and canes. This fact coupled with the elastomeric quality of the molded plastic housing 2 means that the housing 2 of the present invention can consistently interact with most canes and crutches.

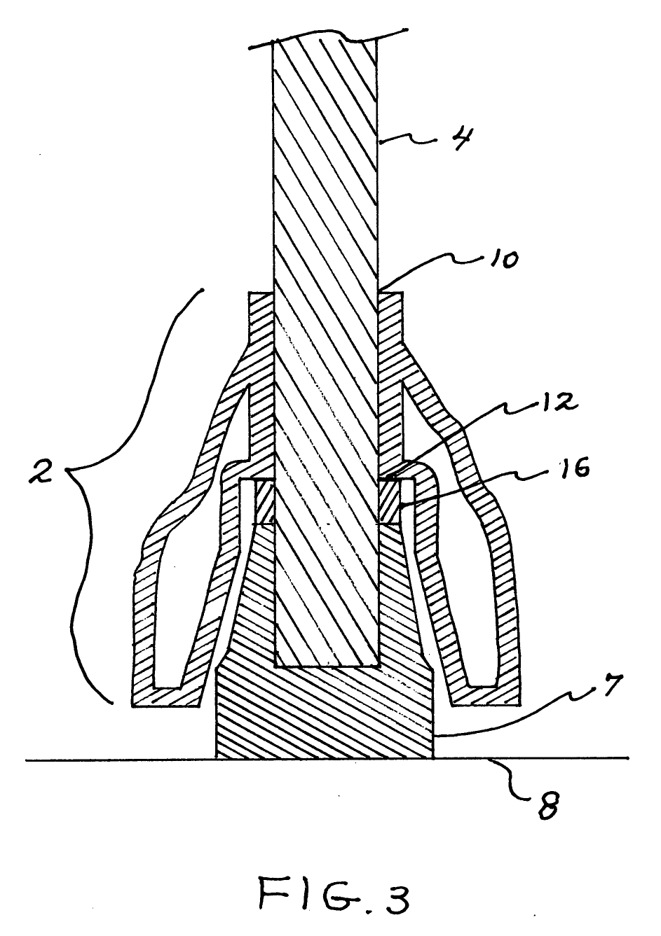

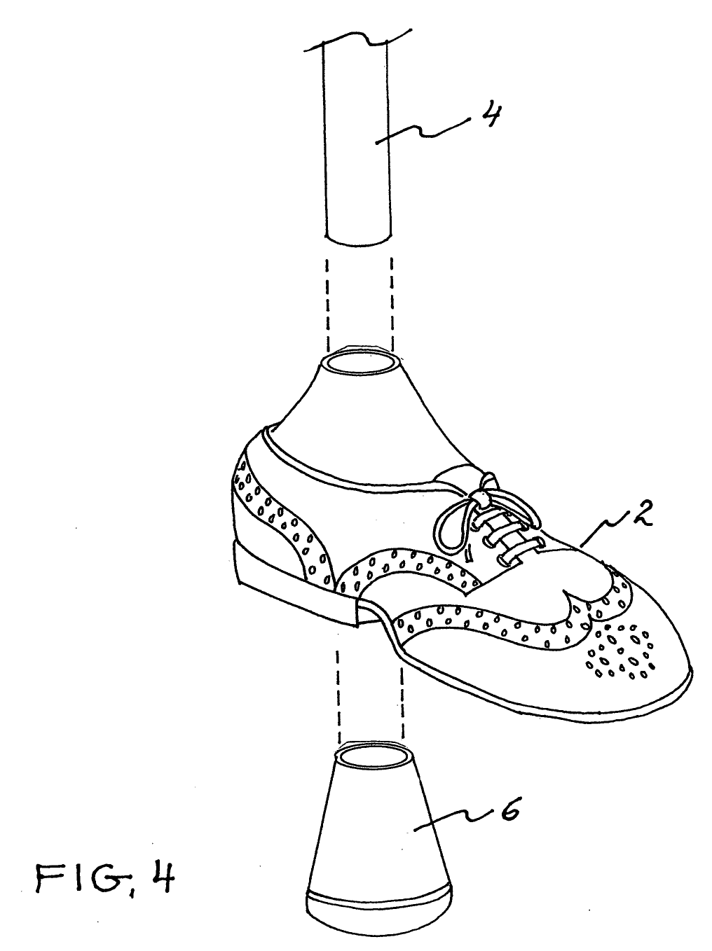

FIG. 3 shows a similar front section view as in FIG. 2 except that this view shows a smaller rubber tip 7 that has a shorter overall height, therefore creating the necessity for an adaptor ring 16 to allow the housing 2 to remain at least one half of one inch above the ground plane 8. My research has shown that there are primarily two distinct rubber tip designs. One is larger and has a slightly flared bottom 6 as shown in FIG. 2. and is commonly used on crutches. The other tip 7 is more commonly used on canes as shown in FIG. 3.

As shown in FIG. 4, to install the housing 2 the user can remove tip 6 from shaft 4, slide on housing 2 onto shaft 4 and then replace tip 6. Alternately, because of the elasticity of the plastic used in molded housing 2, the user can elect to keep the crutch tip 6 in place on shaft 4 and manually enlarge the diameter of aperture 10 so that it can temporarily slip over tip 6 until it clears the tip edge 12 and returns to its normal diameter. The housing 2 is simple and economical to manufacture and, as stated earlier, does not interfere with the normal operation of a standard crutch or cane.

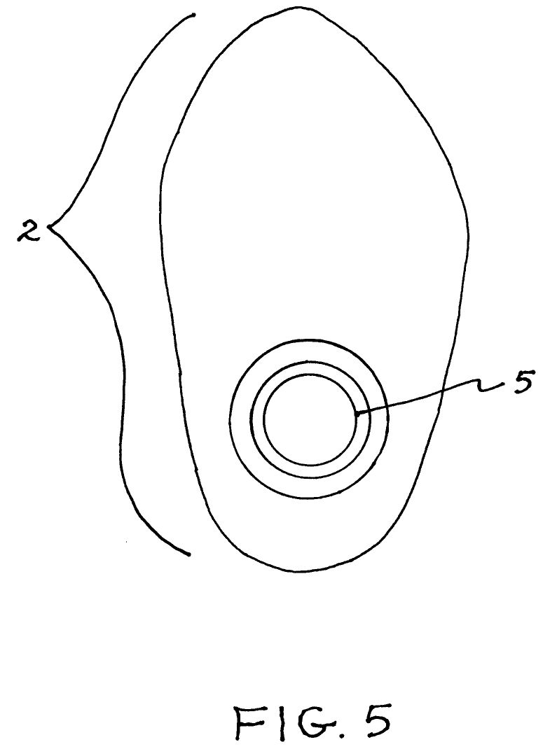

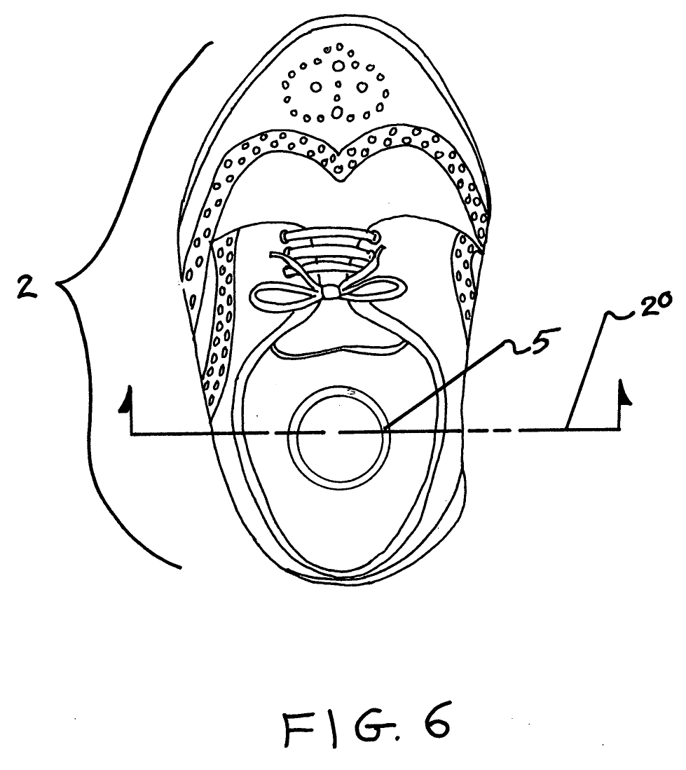

FIG. 5 shows a bottom view of the housing 2

FIG. 6 shows a top view of the housing 2

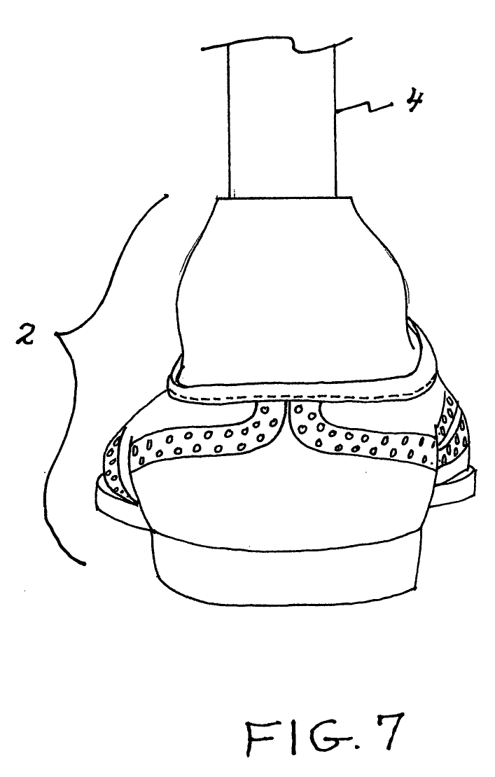

FIG. 7 shows a rear perspective view of the housing 2

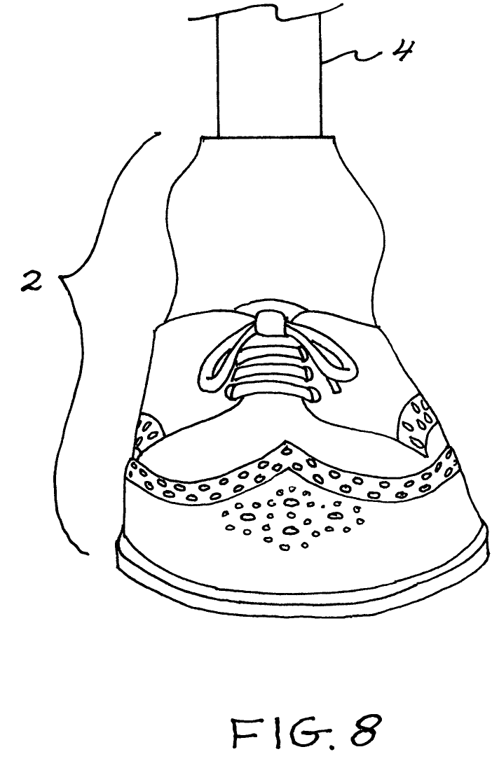

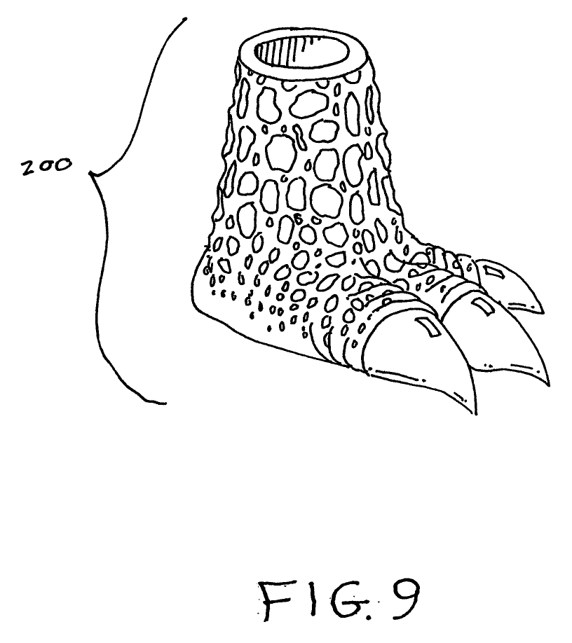

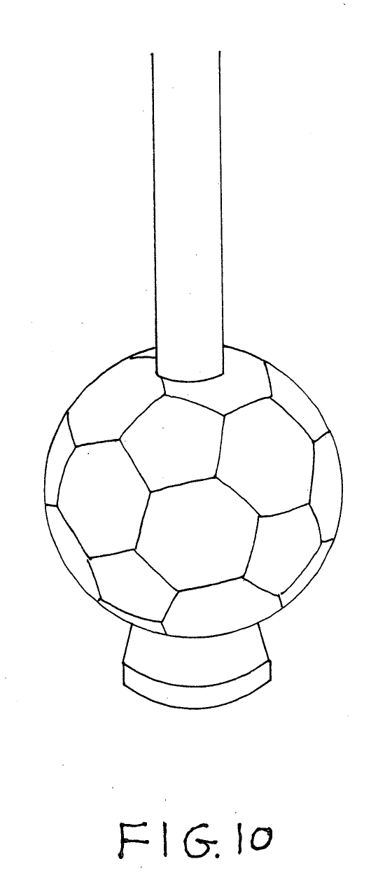

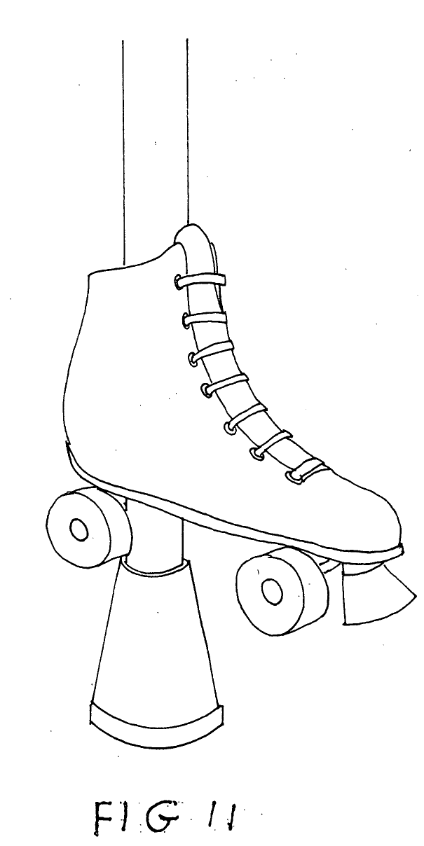

FIG. 8 shows a front perspective view of the housing 2

FIG. 9 shows an alternate embodiment 200 of the crutch foot of the present invention that includes a similar internal structure as shown in the preferred embodiment for retaining the housing to a crutch shaft and for creating the condition where the bottom of the foot 200 remains at least one half of an inch above the ground plane. Obviously, the crutch foot of the present invention can be a designed to represent various types of feet or shoes or even other objects such as baseballs, footballs, basketballs, tennis balls, skis, roller skates, hiking boots or show shoes. The crutch foot of the present invention will help young and old alike to make the best and add some levity to an otherwise difficult and solemn situation.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1-9. (canceled)

10. Crutch foot comprising;
A foot or shoe shaped housing made of molded elastomeric plastic;
Said housing including an aperture that can slidably and fricionally engaged with the lower portion of a crutch or cane shaft;
Said aperture's lowest surface sized to abut the top most surface of said cane's or said crutch's rubber tip so that the bottom most surface of said housing remains approximately one half of one inch above the ground plane when said crutch or said cane is in use by a person;
wherein said housing is constructed of a low durometer plastic so that said aperture is capable of stretching over said crutch of can rubber tip and then returning to a standard crutch shaft dimension and
wherein said crutch foot further comprises an adaptor ring that has a similar inside diameter to said housing aperture and that can be added between said housing aperture bottom and said rubber crutch or cane tip that allows said housing to remain at said proper height off said ground plane when said cane or said crutch includes a rubber tip that is lower in height than the standard rubber crutch or cane tip.

11. Crutch foot as claimed in claim 10 wherein said housing is shaped like a miniature version of a men's or woman's shoe.

12. Crutch foot as claimed in claim 10 wherein said housing is shaped like a miniature version of an animal's foot.

13. Crutch foot as claimed in claim 10 wherein said housing is shaped like a miniature version of a dinosaur foot.

14. Crutch foot as claimed in claim 10 wherein said housing is shaped like a sports ball.

15. Crutch foot as claimed in claim 10 wherein said housing is shaped like a ski.

16. Crutch foot as claimed in claim 10 wherein said housing is shaped like a roller skate.
